(19) United States
(12) Patent Application Publication
(10) Pub. No.: US 2025/0298134 A1
(43) Pub. Date: Sep. 25, 2025

(54) METHOD AND APPARATUS FOR DETECTING OBSTRUCTION FOR LIDAR, AND STORAGE MEDIUM

(71) Applicant: HESAI TECHNOLOGY CO., LTD., Shanghai (CN)

(72) Inventors: Qingguo YU, Shanghai (CN); Junjie ZHANG, Shanghai (CN); Xin ZHAO, Shanghai (CN); Shaoqing XIANG, Shanghai (CN)

(73) Assignee: HESAI TECHNOLOGY CO., LTD., Shanghai (CN)

(21) Appl. No.: 19/231,384

(22) Filed: Jun. 6, 2025

Related U.S. Application Data
(63) Continuation of application No. PCT/CN2023/137137, filed on Dec. 7, 2023.

(30) Foreign Application Priority Data
Dec. 7, 2022 (CN) 202211566326.1

(51) Int. Cl. G01S 7/497; G01S 17/89

(52) U.S. Cl. CPC G01S 7/497; G01S 17/89; G01S 2007/4975

(57) ABSTRACT

A method for detecting an obstruction includes: a detection pulse signal is emitted for probing the obstruction within a ranging time window; the ranging time window is configured to determine a time of flight between emission of a probe pulse signal for probing a target object and reception of an echo from the target object; a stray light echo corresponding to the detection pulse signal is received; whether the obstruction exists is determined based on a feature parameter of the stray light echo.

### CROSS-REFERENCE TO RELATED APPLICATION(S)

This application claims priority to Chinese Patent Application No. 202211566326.1, filed on Dec. 7, 2022, the content of which is incorporated herein by reference in its entirety.

### TECHNICAL FIELD

This disclosure relates to the field of LiDARs and, in particular, to LiDARs, methods and apparatuses for detecting an obstruction therefor, and storage mediums.

### BACKGROUND

The LiDAR is an important sensor for autonomous driving. The LiDAR can include a laser emission apparatus, a laser reception apparatus, and a light cover (which can also be called “a window”). The light cover is an important part of the laser emission and reception paths. The light cover can protect the internal optical and circuit components of the LiDAR. The light cover can protect the LiDAR from external ambient light. The LiDAR is a non-contact measurement device. The cleanliness of the light cover and another obstruction that blocks the light-emitting path of the LiDAR can directly affect the ranging and measurement accuracy of the LiDAR. In an optical system of a coaxial light path (which can be called “coaxial optical system”), when the light emission apparatus generates a light beam, the stray light generated inside the LiDAR can be reflected in the LiDAR and received by the light reception apparatus to form a stray light echo. The stray light echo can be located in a fixed time window.

Referring to FIG. 1, dirt exists on a light cover of a LiDAR with a coaxial optical system. When a light emission apparatus of the LiDAR emits a probe pulse signal, the dirt reflects the probe pulse signal to generate stray light. The stray light can be reflected in the LiDAR and received by a light reception apparatus, which forms a stray light echo.

Typically, the possible impact of the dirt on the light cover of the LiDAR point cloud mainly includes:

1) The power of the probe light beam incident on a target object can be weakened. Ranging capability and reflectivity can be decreased.

2) After the light beam is reflected by the target object, the power of the light beam incident on the light reception apparatus of the LiDAR can be weakened. The ranging capability and the reflectivity can be decreased.

3) The direction of the probe light beam emitted from the light cover of the LiDAR changes, position information of part of the point cloud can be inaccurate.

4) The echo reflected by the dirt can cause an increase in noise in the point cloud.

Referring to FIG. 2, the stray light echo is formed almost simultaneously after the probe pulse signal is emitted from the light emission apparatus. When the emission time of the probe pulse signal is determined, the waveform of the stray light echo can be located in a relatively fixed time window. The temporal relationship between the probe pulse signal and the waveform of the stray light echo is shown in the curves in FIG. 2. The curve 1 represents the time sequence of the probe pulse signal. The curve 2 represents the waveform of the stray light echo before the light cover becomes dirty. And the curve 3 represents the waveform of the stray light echo after the light cover becomes dirty.

The probe pulse signal can be emitted within an emission time window. The stray light echo before an object echo is collected. When dirt or another obstruction exists on the light cover, the peak value, the pulse width, and the integral value in the stray light echo can increase to a certain extent. The dirt or the other obstruction can be detected.

Referring to FIG. 3, the horizontal axis represents the time of flight (TOF), and the vertical axis represents the voltage waveform. The light emission apparatus can emit a probe pulse signal within an emission time window. The light reception apparatus can receive a stray light echo before the object echo. The waveform of the stray light echo when no obstruction exists on the light cover and the waveform of the stray light echo when an obstruction exists on the light cover are shown in FIG. 3. Referring to FIGS. 2 and 3, the obstruction increases the peak value, the pulse width, and the integral value of the stray light echo to some extent, especially the peak value and the integral value. The obstruction can be detected. For example, the obstruction can be identified by comparing the intensity of the stray light echo within the time window t1-t2 with the threshold thres2.

In some examples, the LiDAR can use single-photon detectors. Because the single-photon detectors can receive the stray light inside the LiDAR first, a large number of pixels in the single-photon detectors cannot continue to probe an object echo. The detection capability can be restored only after a certain period of time. Means of reducing the stray light are important to the detection capability of the single-photon detector. For example, the bias voltage of the single-photon detector can be controlled so that no bias voltage or a very small voltage is applied to the single-photon detectors when the probe pulse signal is emitted. However, the stray light echo can be generally a short-range echo, the photon probe efficiency of the detector can be still very low when the stray light echo is returned. The received stray light echo can be very weak or even the stray light echo can disappear, resulting in a poor detection effect on the obstruction.

### SUMMARY

This disclosure provides LiDARs, methods and apparatuses for detecting an obstruction therefor, and storage mediums. The accuracy of the obstruction detection can be improved.

In a first aspect, this disclosure provides a method for detecting an obstruction for a LiDAR, including: emitting, within a ranging time window, a detection pulse signal, the ranging time window is configured to determine a time of flight between emission of a probe pulse signal for probing a target object and reception of an echo from the target object; receiving a stray light echo corresponding to the detection pulse signal; and determining whether an obstruction exists based on a feature parameter of the stray light echo.

Optionally, the determining whether an obstruction exists based on a feature parameter of the stray light echo includes: when the feature parameter of the stray light echo reaches an obstruction identification threshold, determining that the obstruction exists. The feature parameter of the stray light echo includes at least one of a pulse width, a peak value, and an integral value of the stray light echo.

Optionally, the obstruction identification threshold is set by counting feature parameters of stray light echoes of a plurality of LiDARs with an obstruction and the feature parameters of the stray light echoes of the plurality of LiDARs without an obstruction.

Optionally, the obstruction identification threshold is dynamically changed based on a change in an environment in which the LiDAR is located.

Optionally, the emitting, within a ranging time window, a detection pulse signal includes: emitting the detection pulse signal within a first-time window; or emitting the detection pulse signal within a second-time window. The first-time window is at an end position within the ranging time window, the second-time window is within the ranging time window. The second-time window is changed based on a reception time of the echo from the target object.

Optionally, the ranging time window includes a first ranging time window and a second ranging time window, and the emitting, within a ranging time window, a detection pulse signal includes: emitting the detection pulse signal within the first ranging time window, wherein the first ranging time window is configured to determine a time of flight between emission of a probe pulse signal for probing a short-range target object and reception of an echo from the short-range target object; and/or emitting the detection pulse signal within the second ranging time window, wherein the second ranging time window is configured to determine a time of flight between emission of a probe pulse signal for probing a long-range target object and reception of an echo from the long-range target object.

Optionally, a time length of a time window for probing the obstruction is less than a time length of the ranging time window.

Optionally, a light intensity of the detection pulse signal is less than a light intensity of the probe pulse signal.

Optionally, the light intensity of the detection pulse signal is selected from a light intensity range, a maximum value of the light intensity range is determined by counting light intensities of detection pulse signals, based on a determination that no obstruction exists, of a plurality of LiDARs without an obstruction, and a minimum value of the light intensity range is determined by counting light intensities of detection pulse signals, which generate identifiable stray light echoes, of the plurality of LiDARs with an obstruction.

Optionally, the method for detecting an obstruction for a LiDAR, further includes: determining a region in which the obstruction is located based on a point cloud feature deviation between first point cloud data and second point cloud data, wherein the first point cloud data is point cloud data collected before the obstruction is detected, the second point cloud data is point cloud data collected after the obstruction is detected, and the point cloud feature deviation includes a distance deviation and/or a reflectivity deviation.

Optionally, the determining a region in which the obstruction is located based on a point cloud feature deviation between first point cloud data and second point cloud data includes: determining abnormal point cloud data in the second point cloud data based on the point cloud feature deviation; and determining the region in which the obstruction is located based on a probe field of view range of a probe pulse signal corresponding to the abnormal point cloud data.

Optionally, the method for detecting an obstruction further includes: when an obstruction determined based on a plurality of consecutive frames of point clouds is located in one and the same region, determining that the obstruction exists in the region.

Optionally, the method for detecting an obstruction further includes: determining a region in which the obstruction is located based on a position at which a light-emitting channel emitting the detection pulse signal is located in a vertical direction and a horizontal field of view corresponding to the light-emitting channel.

Optionally, the region in which the obstruction is located includes a vertical position and a horizontal position, and the determining a region in which the obstruction is located based on a position at which a light-emitting channel emitting the detection pulse signal is located in a vertical direction and a horizontal field of view corresponding to the light-emitting channel includes: determining the vertical position based on a position at which a light emitter bank, in which the light-emitting channel is located, is located in the vertical direction; and determining the horizontal position based on the horizontal field of view.

Optionally, the method for detecting an obstruction further includes: counting a plurality of regions in which a determined obstruction is located; and when the plurality of regions are spatially continuous, determining that the obstruction exists in the plurality of regions.

Optionally, the stray light echo is echoes corresponding to detection pulse signals emitted by a plurality of light-emitting channels in a plurality of light emitter banks, and the method further includes: counting a number of first light-emitting channels, which correspond to stray light echoes reaching an obstruction identification threshold, in each light emitter bank; and when the number of first light-emitting channels in the same light emitter bank reaches a first threshold, determining that the obstruction exists.

Optionally, the determining whether an obstruction exists based on a feature parameter of the stray light echo includes: when the feature parameter of the stray light echo reaches a first obstruction identification threshold, determining that a first obstruction exists, wherein a type of the first obstruction is a transmissive obstruction; and when the feature parameter of the stray light echo reaches a second obstruction identification threshold, determining that a second obstruction exists, wherein a type of the second obstruction is a non-transmissive obstruction, and the second obstruction identification threshold is greater than the first obstruction identification threshold.

Optionally, the stray light echo is echoes corresponding to detection pulse signals emitted by a plurality of light-emitting channels in a plurality of light emitter banks, and the method further includes: when the obstruction is determined to exist, counting a number of first light-emitting channels, which correspond to stray light echoes reaching an obstruction identification threshold, in each light emitter bank; and determining a type of the obstruction based on the number of first light-emitting channels.

Optionally, the method for detecting an obstruction further includes: when the obstruction is determined to exist, outputting alarm information; wherein the alarm information is used for indicating one or more of the following: the presence of the obstruction, a region in which the obstruction is located, a type of the obstruction, and control information, and the control information is used for controlling the LiDAR or a device mounted on the LiDAR.

In a second aspect, this disclosure provides an apparatus for detecting an obstruction for a LiDAR, including: a control module, configured to control emission of a detection pulse signal for probing the obstruction within a ranging time window and control reception of a stray light echo corresponding to the detection pulse signal, wherein the ranging time window is configured to determine a time of flight between emission of a probe pulse signal for probing a target object and reception of an echo from the target object; and a determination module, configured to determine whether an obstruction exists based on a feature parameter of the stray light echo.

In a third aspect, this disclosure provides a computer-readable storage medium with a computer program stored thereon, wherein the computer program, when run by a computer, executes steps of the method for detecting an obstruction for a LiDAR.

In a fourth aspect, this disclosure provides a LiDAR, including: a light emission apparatus, configured to emit a probe pulse signal for probing a target object and a detection pulse signal for probing an obstruction; a light reception apparatus, configured to receive an echo generated by the probe pulse signal via the target object and a stray light echo corresponding to the detection pulse signal; and a controller with a computer program stored thereon, wherein the controller, when running the computer program, executes steps of the method for detecting an obstruction for a LiDAR.

In a fifth aspect, this disclosure also provides a terminal device, including a memory and a processor, the memory having stored thereon a computer program runnable on the processor, and the processor, when running the computer program, executes the steps of the method for detecting an obstruction for a LiDAR described above.

Optionally, the terminal device includes a LiDAR, a vehicle, a drone, or a robot.

In this disclosure, a light emission apparatus of a LiDAR can emit a detection pulse signal for probing an obstruction within a ranging time window. A light reception apparatus of the LiDAR can receive a stray light echo corresponding to the detection pulse signal. Whether an obstruction exists can be determined based on a feature parameter of the stray light echo. The detection pulse signal can be a pulse signal used to detecting the obstruction. The detection pulse signal and the probe pulse signal can be two independent pulse signals. The detection of the obstruction can be achieved without affecting the detection of a target object. By doing so, the stray light echo generated by the detection pulse signal can be not affected by the echo from the target object or the means of reducing the stray light. The accuracy of the obstruction detection can be improved or ensured. In addition, the detection pulse signal is not used for ranging, and the echo from the target object does not need to be received, as long as the waveform of the stray light echo is measurable. The measurement time window of the stray light echo generated by the detection pulse signal can be small, which is implementable when the available time resources in the LiDAR are tight. Both the target object detection function and the obstruction detection function of the LiDAR can be achieved. Further, the light intensity of the detection pulse signal can be smaller than the light intensity of the probe pulse signal. The light intensity of the detection pulse signal in this disclosure can be configured to enable the light reception apparatus to receive and detect the stray light echo. The light intensity of the detection pulse signal can be set to be smaller. The feature parameter of the stray light echo can change significantly when an obstruction exists. By doing so, the obstruction can be detected more easily and the impact on the target object detection performance of the LiDAR can be reduced.

### BRIEF DESCRIPTION OF THE DRAWINGS

FIG. 1 shows a schematic diagram of dirt on a light cover blocking an emission light path in the existing art.

FIG. 2 shows a schematic diagram of a waveform of a stray light echo in the existing art.

FIG. 3 shows a schematic diagram of a waveform of another stray light echo in the existing art.

FIG. 4 shows a flowchart of an example method for detecting an obstruction, consistent with some embodiments of this disclosure.

FIG. 5 shows a schematic diagram of various example echo waveforms, consistent with some embodiments of this disclosure.

FIG. 6 shows an example schematic diagram of a time window for emitting a detection pulse signal, consistent with some embodiments of this disclosure.

FIG. 7 shows an example schematic diagram of another time window for emitting a detection pulse signal, consistent with some embodiments of this disclosure.

FIG. 8 shows an example schematic diagram of a further time window for emitting a detection pulse signal, consistent with some embodiments of this disclosure.

FIG. 9 shows a schematic diagram of example feature parameters of a stray light echo, consistent with some embodiments of this disclosure.

FIG. 10 shows a schematic diagram of an example region division, consistent with some embodiments of this disclosure.

FIG. 11 shows a schematic diagram of the energy of a probe pulse signal of a laser, consistent with some embodiments of this disclosure.

FIG. 12 shows an example schematic diagram of pulse signals with different types of obstructions, consistent with some embodiments of this disclosure.

FIG. 13 shows another example schematic diagram of pulse signals with various types of obstructions, consistent with some embodiments of this disclosure.

FIG. 14 shows a structure schematic diagram of an example apparatus for detecting an obstruction, consistent with some embodiments of this disclosure.

FIG. 15 shows an example structure schematic diagram of a LiDAR, consistent with some embodiments of this disclosure.

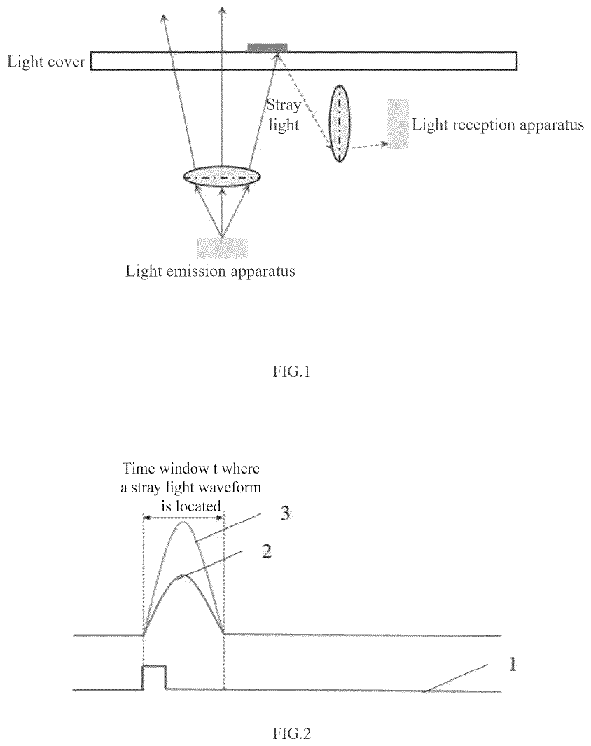

### DETAILED DESCRIPTION

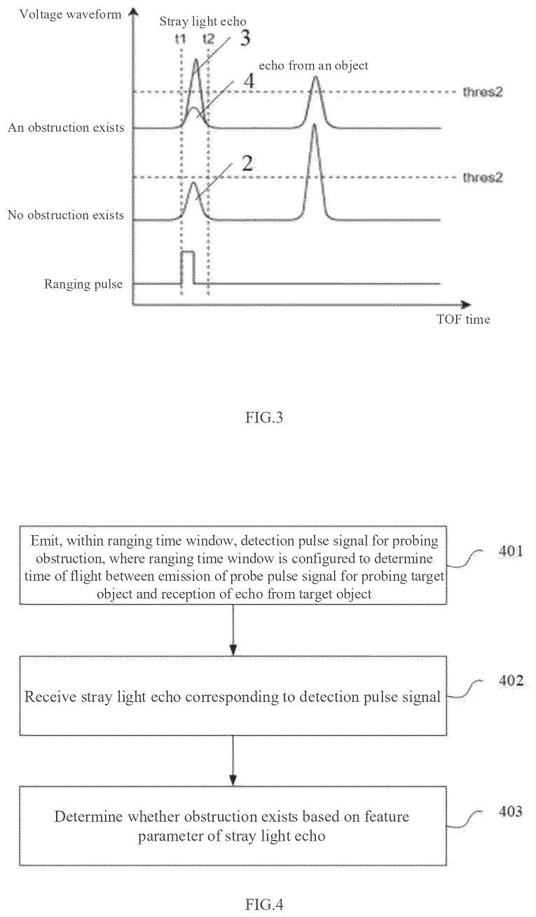

A LIDAR can uses some means of reducing the stray light to ensure the detection capability of the single-photon detector and enhance the ranging capability. For example, the bias voltage of the single-photon detector can be controlled such that no bias voltage or a very small voltage can be applied to the single-photon detector when the probe pulse signal is emitted. Because the stray light echo can be generally a short-range echo, the photon probe efficiency of the detector can be still very low when the stray light echo is returned. The collected stray light echo is very weak or even the stray light echo disappears, referring to the curve 4 in FIG. 3. The intensity of the stray light echo at this point can do not exceed the threshold thres2, resulting in a poor detection effect on the obstruction, and missing detection is easily caused. In addition, to ensure the ranging capability, the probe pulse signal of the LiDAR can be strong and not sensitive to the change (e.g., increase) in the feature parameter of the stray light echo caused by the obstruction. The main function of the probe pulse signal is to range the target object. The generation of a stray light echo with a certain intensity to detect the obstruction is not considered in the setting of the intensity of the probe pulse signal.

In some embodiments, the detection pulse signal can be a pulse signal for detecting the obstruction. The detection pulse signal and the probe pulse signal are two independent pulse signals. The detection of the obstruction can be achieved without affecting the detection of the target object. The stray light echo can be not affected by the echo of the target object or the means of reducing the stray light. In addition, the detection pulse signal can be not used for ranging. The echo of the target object can be not received, as long as the waveform of the stray light echo can be measurable. The measurement time window of the stray light echo can be small. It is implementable when the available time resources in the LiDAR are tight. Both the target object detection function and the obstruction detection function of the LiDAR can be achieved. In addition, the detection pulse signal and the probe pulse signal are independent of each other. The means of suppressing the stray light can no longer be used when the detection pulse signal is emitted. By doing so, the measurability of the stray light echo can be ensured. The detection of the obstruction based on the feature parameter of the stray light echo can be achieved. The accuracy of the detection of the obstruction can be improved.

To make the above objects, features, and advantages of the application clearer and more comprehensible, some embodiments of the application are described in detail below in conjunction with the drawings.

FIG. 4 shows a flowchart of an example method for detecting an obstruction, consistent with some embodiments of this disclosure. Referring to FIG. 4, the example method can include the following steps.

In step 401, a detection pulse signal for detecting an obstruction is emitted within a ranging time window. The ranging time window is configured to determine a time of flight between the emission of a probe pulse signal for probing a target object and the reception of an echo from the target object.

In step 402, a stray light echo corresponding to the detection pulse signal is received.

In step 403, whether the obstruction exists is determined based on a feature parameter of the stray light echo.

In some embodiments, the obstruction can be dirt on the surface of the light cover or another short-range object other than the target object, which can block the emission light path to generate a stray light echo. For example, the obstruction can be a moving insect. For another example, the obstruction can also be weather or environment issue, such as rain, snow, fog, frost, ice, haze, sandstorm, or the like. All of the above obstructions can generate stray light echoes.

In some embodiments, in step 401, the light emission apparatus of a LiDAR can emit a detection pulse signal within a ranging time window. The detection pulse signal is a pulse signal for probing the obstruction. The probe pulse signal is a pulse signal for probing a target object. The detection pulse signal and the probe pulse signal are two independent pulse signals. The ranging time window is configured to determine a time of flight between the emission of the probe pulse signal and the reception of the echo from the target object.

When the obstruction exists, the obstruction can generate a stray light echo for the detection pulse signal. For example, the obstruction can reflect or refract the detection pulse signal to generate a stray light echo. In some embodiments, in step 402, the light reception apparatus of the LiDAR can receive the stray light echo.

In some embodiments, the obstruction can be the dirt on the light cover. The stray light echo can be formed almost simultaneously after the light emission apparatus emits the detection pulse signal. The time window in which the stray light echo is located can be determined based on the emission time of the detection pulse signal.

In some embodiments, the process of determining the time of flight can refer to the process where the light emission apparatus emits the detection pulse signal, the light reception apparatus receives the echo from the target object, and the LiDAR processes the echo. Accordingly, the ranging time window can include a time window 1 and a time window 2. The time window is used for emitting the probe pulse signal and receiving the echo from the target object. The time window 2 is used for signal transmission and processing after the echo is received. The time length of the time window 1 is the time length between the emission of the detection pulse signal by the light emission apparatus and the reception of the echo from the target object corresponding to the furthest-ranging capability of the LiDAR.

In some embodiments, after the echo from the target object is received, because the time for the LiDAR to process the echo is long, the LiDAR can no longer emit any probe pulse signal within the time range (e.g., within the time window 2). The time range can be a time range between the time when the light reception apparatus receives the echo from the target object and the end time of the ranging time window. The detection pulse signal can be emitted within the time range. The detection pulse signal can be emitted within the time window 2. In some embodiments, in step 401, the detection pulse signal can be emitted within a first-time window. The first-time window can be located at the end position within the ranging time window.

FIG. 5 shows a schematic diagram of various example echo waveforms, consistent with some embodiments of this disclosure.

Referring to FIG. 5, the timestamp t1 represents the time when the probe pulse signal is emitted. t1-t2 represents the time window where the stray light echo 1 generated by the probe pulse signal is received. t3-t4 represents the emission window where the detection pulse signal is emitted (e.g., the first-time window, or a second-time window). In a case that the detection pulse signal is emitted at the timestamp t3, t3-t4 represents the time window where the stray light echo 2 generated by the detection pulse signal is received. t1-t6 represents the time window 1 where the probe pulse signal is emitted and the echo from the target object is received. t6-t5 represents the time window 2 for signal transmission and processing after the echo from the target object is received. t1-t5 represents the ranging time window.

The light emission apparatus can emit the detection pulse signal within the first-time window t3-t4. The first-time window t3-t4 is located at the end position within the ranging time window t1-t5. The relative position between the first-time window t3-t4 and the ranging time window t1-t5 are fixed and can be predetermined. For example, the start timestamp t3 of the first-time window t3-t4 can be predetermined based on the timestamp t1 when the probe pulse signal is emitted.

The first-time window t3-t4 is at the end position within the ranging time window t1-t5. At this time, the echo from the target object can have already been received by the light reception apparatus. The detection pulse signal can be emitted within the first-time window t3-t4. The stray light echo generated by the detection pulse signal can do not affect the reception of the echo from the target object. The stray light echo can do not affect the detection of the target object by the LiDAR.

In some exist techniques, within the time window t1-t2, the intensity of the stray light echo in the presence and absence of the obstruction does not exceed the threshold thres1 due to the use of the means of reducing the stray light. The obstruction cannot be detected. The detection pulse signal and the probe pulse signal in this disclosure can be two independent pulse signals. The detection of the obstruction can be achieved without affecting the detection of the target object. By doing so, the stray light echo generated by the detection pulse signal can be not affected by the echo from the target object or the means of reducing the stray light. The accuracy of the obstruction detection can be improved, or ensured, or not decreased.

In some embodiments, in step 401, the detection pulse signal can be emitted within a second-time window that is within the ranging time window. The second-time window can be changed based on the reception time of an echo from the target object.

Referring to FIG. 5, the light emission apparatus can emit the detection pulse signal within the second-time window t3-t4. The time when the light reception apparatus receives the complete echo from the target object is t6. The second-time window t3-t4 can be changed based on the reception timestamp t6 of the echo from the target object. The light emission apparatus can emit the detection pulse signal again after the light reception apparatus receives the echo from the target object. For example, the later the reception timestamp t6 of the echo from the target object is, the later the start timestamp t3 of the second-time window is.

In some embodiments, the start timestamp t3 of the second-time window t3-t4 can have a fixed offset from the reception timestamp t6 of the echo from the target object. In some embodiments, the end timestamp t4 of the second-time window t3-t4 can have a fixed offset from the reception timestamp t6 of the echo from the target object.

In some embodiments, the first-time window and the second-time window represent a time window for detecting the obstruction. The time length of the time window can be less than the time length of the ranging time window. Further, the time lengths of the first-time window and the second-time window can be less than the time length of the time window 1 or the time window 2.

In some embodiments, the time lengths of the first-time window and the second-time window can be set based on the actual demand, as long as the complete stray light echo can be received, which is not limited in this disclosure. For example, the time length of the complete pulse width can be obtained by counting the waveforms of different stray light echoes generated by multiple LiDARs, and the longest time can be taken.

In some embodiments, in step 401, the ranging time window can include a first ranging time window and a second ranging time window. The first ranging time window can be configured to determine a time of flight between the emission of a probe pulse signal for probing a short-range target object and the reception of an echo from the short-range target object. The second ranging time window is configured to determine a time of flight between the emission of a probe pulse signal for probing a long-range target object and the reception of an echo from the long-range target object. Further, the first ranging time window can include a time window 1 and a time window 2. The time widow 1 is used for emitting the probe pulse signal and receiving the echo from the target object. The time window 2 is used for signal transmission and processing after the echo from the target object is received. The second ranging time window can also include a time window 1 and a time window 2.

In some embodiments, the light emission apparatus can emit the detection pulse signal within the first ranging time window; and/or, the light emission apparatus can emit the detection pulse signal within the second ranging time window. For example, the detection pulse signal is emitted at the end position within the first ranging time window, and/or the second ranging time window.

In some embodiments, the light emission apparatus of the LiDAR can emit pulses in the manner of double time windows. The light emission apparatus can emit the probe pulse signal for detecting a short-range target object within the first ranging time window. The light emission apparatus can emit the probe pulse signal for detecting a long-range target object within the second ranging time window.

For example, the light emission apparatus can emit the probe pulse signal within the first range time window by the means of reducing the stray light to attenuate the stray light echo. To avoid or reduce the effect of the means of reducing the stray light on the stray light echo, the light emission apparatus can set the obstruction detection time window at the end of the first ranging time window for the measurement of the stray light echo. The light emission apparatus can emit the detection pulse signal at the end of the first ranging time window. Because the light intensity of the detection pulse signal is small, the detection pulse signal does not affect the ranging of the target object.

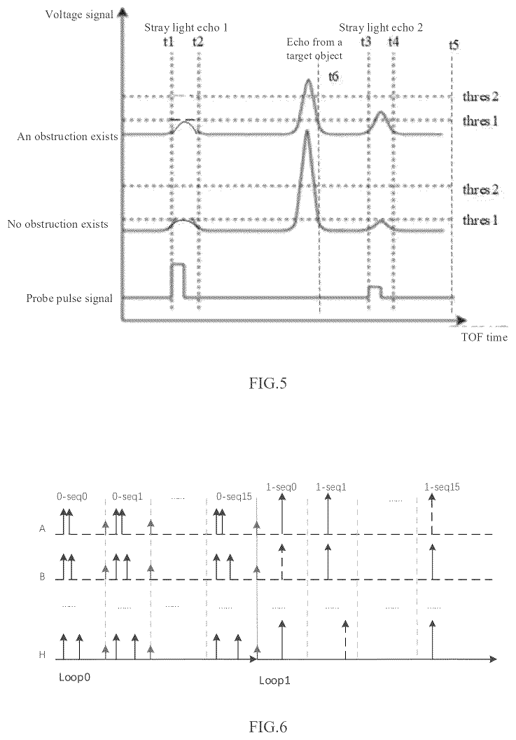

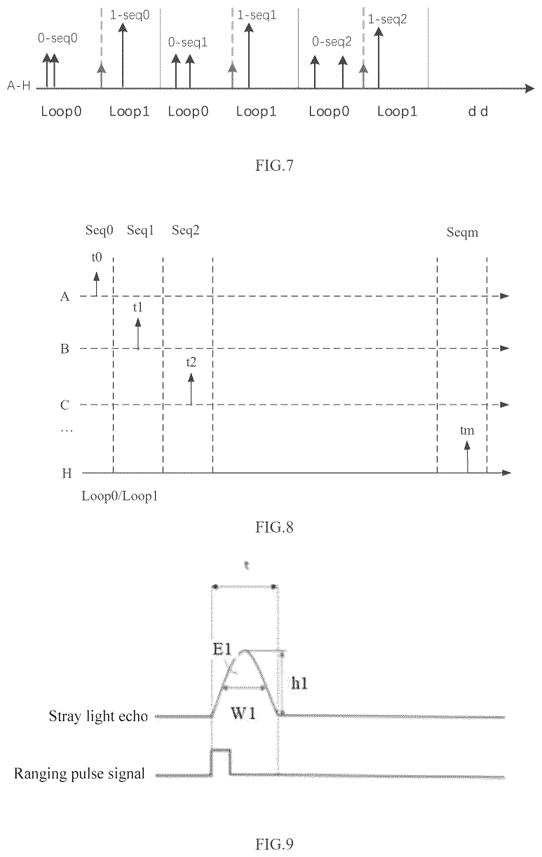

FIG. 6 shows an example schematic diagram of a time window for emitting a detection pulse signal, consistent with some embodiments of this disclosure. FIG. 7 shows an example schematic diagram of another time window for emitting a detection pulse signal, consistent with some embodiments of this disclosure.

In some embodiments, the light emission apparatus of the LiDAR can include a plurality of light emitter banks. Each light emitter bank can include a plurality of light-emitting channels. The plurality of light-emitting channels can emit light in turn (e.g., sequentially emit light). For example, the LiDAR includes 8 light emitter banks (e.g., bank A-H). Each light emitter bank includes 16 light-emitting channels. Referring to FIG. 6 and FIG. 7, the light emitting time sequence of the 16 light-emitting channels corresponds to time sequence 0 (e.g., “seq0” in FIGS. 6 and 7) to time sequence 15 (e.g., “seq15” in FIGS. 6 and 7). Loop0 represents the first ranging time window. Loop1 represents the second ranging time window.

In some embodiments, still referring to FIG. 6, multiple light-emitting channels in each light emitter bank emits a randomly encoded probe pulse signal with a smaller intensity within a respective first ranging time window Loop0 sequentially based on a first-time sequence (e.g., 0-seq0 to 0-seq15) to detect a short-range target object. The multiple light-emitting channels in each light emitter bank emits a randomly encoded probe pulse signal with a larger intensity within a respective second ranging time window Loop1 sequentially based on a second time sequence (e.g., 1-seq0 to 1-seq15) to detect a long-range target object. The randomly encoded probe pulse signal can be a pulse signal sequence formed by a plurality of probe pulse signals, such as a pulse signal sequence formed by two probe pulse signals.

The detection pulse signal can be emitted each time at the end of the first ranging time window Loop0 of a previous light-emitting channel of each light emitter bank and before the first ranging time window Loop0 of a next light-emitting channel thereof. For example, the detection pulse signal is emitted at the time shown by the dashed line in FIG. 6.

In some embodiments, referring to FIG. 7, one light-emitting channel in the light emitter banks A-H emits a randomly encoded probe pulse signal with a smaller intensity within the first ranging time window Loop0 based on the first-time sequence 0-seq0 to detect a short-range target object. The light-emitting channel emits a probe pulse signal with a larger intensity within the second ranging time window Loop1 based on the second time sequence 1-seq0 to detect a long-range target object. Similarly, another light-emitting channel in the light emitter banks A-H emits a randomly encoded probe pulse signal with a smaller intensity within the first ranging time window Loop0 based on the first-time sequence 0-seq1. And light-emitting channel in the light emitter banks A-H emits a probe pulse signal with a larger intensity within the second ranging time window Loop1 based on the second time sequence 1-seq1 until all light-emitting channels in the light emitter banks A-H complete the pre-set light-emitting time sequence.

The detection pulse signal can be emitted at the end of the first ranging time window Loop0 of each light-emitting channel and before the second ranging time window Loop1. For example, the detection pulse signal is emitted at the time shown by the dashed line in FIG. 7.

In addition, the light emission apparatus can also emit the detection pulse signal within the second ranging time window Loop1. When the LiDAR detects a short-range target within the first ranging time window Loop0, no probe pulse signal needs to be emitted within the second ranging time window Loop1. The second ranging time window Loop1 can be used as a time window for detecting the obstruction. The light emission apparatus can emit the detection pulse signal within the second ranging time window Loop1.

FIG. 8 shows an example schematic diagram of a further time window for emitting a detection pulse signal, consistent with some embodiments of this disclosure.

In some embodiments, when the light emission apparatus emits the detection pulse signal within the first ranging time window Loop0 or the second ranging time window Loop1 as described above, at least one light-emitting channel can be randomly selected from each emitter bank to emit the detection pulse signal to detect whether the obstruction exists in the detection field of view range corresponding to each emitter bank. The obstruction detection result of at least one light-emitting channel can be taken as the obstruction detection result of the entire emitter bank. Referring to FIG. 8, one light-emitting channel can be randomly selected from each emitter bank to emit the detection pulse signal. For example, the light-emitting channel 1 in the emitter bank A can be selected to emit the detection pulse signal at the timestamp t0. The light-emitting channel 2 in the emitter bank B can be selected to emit the detection pulse signal at the timestamp t1. The light-emitting channel 3 in the emitter bank C can be selected to emit the detection pulse signal at the timestamp t2. The light-emitting channel m in the emitter bank H can be selected to emit the detection pulse signal at the timestamp tm. The light emitting time sequence of the light-emitting channel 1 to the light-emitting channel m can be shown as seq0-seqm in FIG. 8.

In some embodiments, the light intensity of the detection pulse signal can be smaller than the light intensity of the probe pulse signal. The light intensity of the detection pulse signal can be smaller relative to the probe pulse signal. The detection pulse signal can be used for detecting the obstruction instead of performing the ranging of the target object. In some embodiments, the light intensity of the detection pulse signal only needs to satisfy the requirements for the intensity of the generated stray light echo and the change (e.g., increase) in the feature parameter of the stray light echo with the obstruction.

The light intensity of the detection pulse signal can be selected from a light intensity range. The maximum value of the light intensity range can be determined by counting the light intensities of the detection pulse signals, based on which no obstruction is determined to exist, of a plurality of LiDARs without an obstruction. The minimum value of the light intensity range can be determined by counting the light intensities of the detection pulse signals, which generate identifiable stray light echoes, of the plurality of LiDARs with an obstruction. For example, the light intensity range can be predetermined, based on some measurement results (e.g., through some experiments before LiDARs leave the factory, or through some measurement results when the LiDAR works). A plurality of first LiDARs with no obstruction are taken for test. The light intensities of the detection pulse signals can be counted for the maximum value, when no obstruction exists in the first LiDARs is determined. Similar, a plurality of second LiDARs with one or more obstruction are taken for test. The light intensities of the detection pulse signals can be counted for the minimum value, when the obstruction exists in the second LiDARs is determined.

Both the above-mentioned maximum and minimum values can be statistically obtained at full-temperature operating conditions (e.g., −40 degrees to 120 degrees) of the LiDAR.

Still referring to FIG. 1, in step 403, whether the obstruction exists is determined based on a feature parameter of the stray light echo. For example, the feature parameter of the stray light echo can include at least one of a pulse width, a peak value, and an integral value of the stray light echo.

FIG. 9 shows a schematic diagram of example feature parameters of a stray light echo, consistent with some embodiments of this disclosure.

In some embodiments, referring to FIG. 9, the pulse width of the stray light echo is shown as W1, the peak value of the stray light echo is shown as h1. The integral value of the stray light echo represents the integral value of a stray light echo signal within the timestamp t. The integral value is the area of the stray light echo, which is shown as E1.

In some embodiments, the obstruction exists is determined when the feature parameter of the stray light echo reaches an obstruction identification threshold. Further, for different feature parameters of the stray light echo, different obstruction identification thresholds can be used.

Taking the feature parameter as the peak value of the stray light echo as an example, still referring to FIG. 5, when the peak value of the stray light echo reaches the obstruction identification threshold thres1, the obstruction exists can be determined. Accordingly, when the feature parameter is the pulse width of the stray light echo, the corresponding obstruction identification pulse width threshold can be used. When the feature parameter is the integral value of the stray light echo, the corresponding obstruction identification integral threshold can be used.

In some embodiments, the obstruction identification threshold can be set by counting the differences between the feature parameters of the stray light echoes of a plurality of radars with an obstruction and the feature parameters of the stray light echoes of the plurality of radars without an obstruction, to enable the obstruction identification threshold to distinguish between the stray light echo with an obstruction and the stray light echo without an obstruction.

In some embodiments, the obstruction identification threshold can change with changes in the environment in which the LiDAR is located. The obstruction identification threshold is dynamically changed based on changes in the environment in which the LiDAR is located. For example, the obstruction identification threshold thres1 can be changed based on the temperature of the environment in which the LiDAR is located. The obstruction identification thresholds at various temperatures can be counted in advance and stored. In some examples, the obstruction identification threshold can be selected based on the current temperature collected in real time by a temperature sensor inside the LiDAR.

In some embodiments, still referring to FIG. 5, the LiDAR emits the probe pulse signal at the timestamp t1 within the ranging time window and receives the echo from the target object at the timestamp t6. The LiDAR emits the detection pulse signal with a smaller intensity at the timestamp t3, and receives the stray light echo 2 within the time window t3-t4. With an obstruction, the peak value of the stray light echo 2 exceeds the obstruction identification threshold thres1.

Different from the stray light echo 1 received within the time window t1-t2 in the existing technique, the stray light echo 2 in this disclosure can be not affected by the echo from the target object or the means of reducing the stray light. The accuracy of the obstruction detection can be improved, or ensured, or not decreased.

After the obstruction exists is determined, the region in which the obstruction is located within the detection field of view can be further determined. For example, the region in which the obstruction is located on the light cover can be further determined.

In some embodiments, a region in which the obstruction is located can be determined based on a point cloud feature deviation between first point cloud data and second point cloud data. The first point cloud data is point cloud data determined before the obstruction is detected. The second point cloud data is point cloud data determined after the obstruction is detected. The point cloud feature deviation can include a distance deviation and/or a reflectivity deviation.

In some embodiments, abnormal point cloud data in the second point cloud data can be determined based on the point cloud feature deviation. The region in which the obstruction is located can be determined based on a probe field of view range of a probe pulse signal corresponding to the abnormal point cloud data.

In some embodiments, the emission pulse of each light-emitting channel of the LiDAR can have a probe field of view range on the light cover. Each emission pulse can generate corresponding point cloud data. When an obstruction exists on the light cover, the corresponding light-emitting channel can be determined based on the probe field of view range where the obstruction exists on the light cover. Accordingly, the point cloud data generated by the emission pulse of the light-emitting channel becomes abnormal. For example, the distance or the reflectivity is deviated. The abnormal point cloud data can be identified by comparing the normal point cloud data (e.g., the first point cloud data) before the appearance of the obstruction and the second point cloud data after the appearance of the obstruction. The probe field of view range of the emission pulse corresponding to the abnormal point cloud data can be the region in which the obstruction is located.

In some embodiments, a region in which an obstruction is located can be determined based on a plurality of consecutive frames of point clouds. When the obstruction is determined to be located in one and the same region, the obstruction exists in the region is determined. The robustness of the obstruction detection can be improved or ensured.

In some embodiments, the region in which the obstruction is located can also be determined based on the position at which a light-emitting channel emitting the detection pulse signal is located in a vertical direction and a horizontal field of view corresponding to the light-emitting channel. The number of regions can be one or more. The horizontal field of view (FOV) corresponding to each light-emitting channel of the light emission apparatus in the LiDAR can be determined based on an azimuthal angle of the multi-faceted rotating mirror.

The region in which the obstruction is located can include a vertical position and a horizontal position. The vertical position can be determined based on the position at which a light emitter bank in the vertical direction located, in a light emitter bank. The horizontal position can be determined based on the horizontal field of view.

In some embodiments, the LiDAR can include a plurality of light emitter banks. The probe field of view range of the light cover can be divided into a plurality of intervals in the vertical direction through the plurality of light emitter banks. The probe field of view range of the light cover can be divided into a plurality of intervals in the horizontal direction through a plurality of horizontal field of view angles. In a case where an obstruction is detected, a region of the obstruction can be determined based on the light-emitting channel of the emitted detection pulse signal that detects the obstruction.

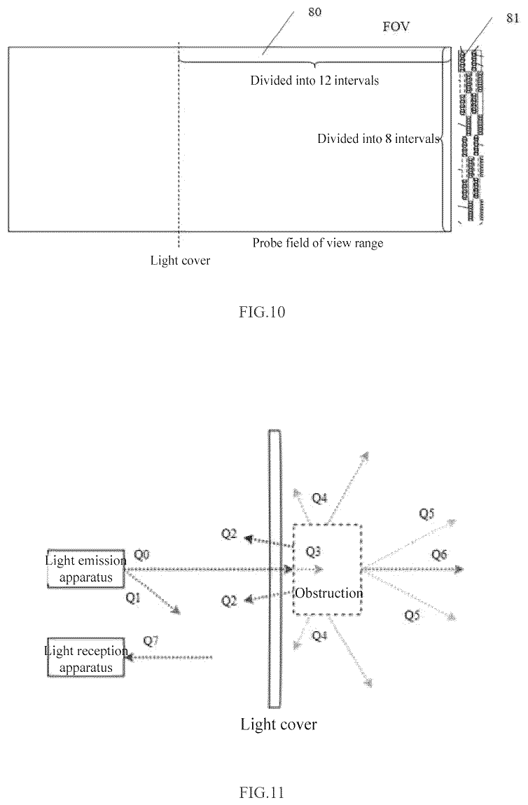

FIG. 10 shows a schematic diagram of an example region division, consistent with some embodiments of this disclosure. In some embodiments, referring to FIG. 10, the LiDAR includes eight light emitter banks 81. The probe field of view range of the light cover 80 is divided into eight vertical intervals in the vertical direction through the eight light emitter banks 81. The horizontal field of view range is 0-120 degrees in the horizontal direction, with a granularity of 10 degrees. The probe field of view range of the light cover 80 is divided into 12 horizontal intervals in the horizontal direction. When the obstruction is determined to exist based on the stray light echo, the detection pulse signal corresponding to the stray light echo can be first determined. A vertical interval can be determined based on the light emitter bank in which the light-emitting channel emitting the detection pulse signal is located. Accordingly, a horizontal interval can be determined based on the horizontal field of view corresponding to the light-emitting channel.

In some embodiments, the light-emitting channel emitting the detection pulse signal can be at least one light-emitting channel in the emitter bank. The obstruction detection result of the at least one light-emitting channel can be taken as the obstruction detection result of the entire emitter bank. The obstruction detection result of the at least one light-emitting channel can also be taken as the detection result of whether an obstruction exists in the probe field of view range corresponding to the entire emitter bank.

Taking Table 1 as an example, an obstruction can be determined to exist in the region formed by the light emitter bank where channels 32-47 are located and the horizontal field of view angles of 20.1-30 degrees, the region formed by the light emitter bank where channels 48-63 are located and the horizontal field of view angles of 20.1-30 degrees, the region formed by the light emitter bank where channel 32-47 are located and the horizontal field of view angles of 30.1-40 degrees, and the region formed by the light emitter bank where channel 48-63 are located and the horizontal field of view angles of 30.1-40 degrees.

TABLE 1

| | | | | | | |
|---|---|---|---|---|---|---|
| 0-10 | 10.1-20 | 20.1-30 | 30.1-40 | . . . | 90.1-100 | 100.1-110 |

| | | |
|---|---|---|
| Channels 0-15 | | |
| Channels 16-31 | | |
| Channels 32-47 | An | An |
| | obstruction | obstruction |
| | exists | exists |
| Channels 48-63 | An | An |
| | obstruction | obstructions |
| | exists | exists |
| . . . | | |
| Channels 112-127 | | |

In some embodiments, a plurality of regions in which the determined obstruction is located can be counted. If the plurality of regions are spatially consecutive, the obstruction is confirmed to exist in the plurality of regions. For example, if the dirt on the light cover is identified in three consecutive intervals, it is considered that the dirt on the light cover exists. False detection can be decreased or avoided. The accuracy of the obstruction detection can be improved or ensured.

In some embodiments, the stray light echo can be echoes corresponding to the detection pulse signals emitted by a plurality of light-emitting channels in a plurality of light emitter banks. The number of first light-emitting channels corresponding to stray light echoes reaching the obstruction identification threshold in each light emitter bank can be counted. When the number of first light-emitting channels in the same light emitter bank reaches a first threshold, the obstruction exists is determined. For example, each light emitter bank includes 16 light-emitting channels. When the number of first light-emitting channels corresponding to stray light echoes reaching the obstruction identification threshold reaches 8, the obstruction can be determined to exist. False detection can be decreased or avoided. The accuracy of the obstruction detection can be improved or ensured.

When the obstruction exists is determined, the type of the obstruction can be further determined. The type of the obstruction can be a transmissive obstruction or a non-transmissive obstruction. The pulse signal can pass through the transmissive obstruction and cannot pass through the non-transmissive obstruction. For example, the transmissive obstruction can include a transmissive obstruction, a refractive obstruction, and a scattering obstruction. The non-transmissive obstruction can include an absorptive obstruction and a reflective obstruction.

The non-transmissive obstruction can include asphalt, paint, dust, dirt, or the like, and the transmissive obstruction can include a scratch, a gravel pit, an insect carcass, a bird dropping, greasy sweat, a fingerprint, sewage, clear water, or the like, which are not enumerated herein.

FIG. 11 shows a schematic diagram of the energy of a probe pulse signal of a laser, consistent with some embodiments of this disclosure. Referring to FIG. 11, Q0 represents laser emission energy. Q1 represents internally consumed laser energy, Q2 represents laser energy reflected by a reflective obstruction. Q3 represents laser energy absorbed by an absorptive obstruction. Q4 represents laser energy scattered by a scattering obstruction. Q5 represents laser energy refracted by a refractive obstruction. Q6 represents laser energy transmitted by a transmissive obstruction. Q7 represents laser energy received by a light reception apparatus.

In some embodiments, different obstruction identification thresholds can be determined for different types of obstructions. For example, two types of above-mentioned obstructions can be determined. The degrees of influence of the two types of above-mentioned obstructions on the change (e.g., increase) in the stray light echo can be determined. Two average values can be determined, such as a first obstruction identification threshold and a second obstruction identification threshold.

For example, when the feature parameter of the stray light echo reaches the first obstruction identification threshold, a first obstruction exists and the type of the first obstruction is a transmissive obstruction can be determined. When the feature parameter of the stray light echo reaches the second obstruction identification threshold, a second obstruction exists and the type of the second obstruction is a non-transmissive obstruction can be determined.

FIG. 12 shows an example schematic diagram of pulse signals with different types of obstructions, consistent with some embodiments of this disclosure. In some embodiments, referring to FIG. 12, the second obstruction identification threshold is greater than the first obstruction identification threshold. The first obstruction identification threshold can distinguish between the stray light echo without an obstruction and the stray light echo with a transmissive obstruction. The second obstruction identification threshold can distinguish between the stray light echo with a transmissive obstruction and the stray light echo with a non-transmissive obstruction.

Different types of obstructions have different effects on the point cloud data, the types of obstructions can reflect the blocking severity degree of the obstruction or dirty degree. For example, the blocking severity degree of the non-transmissive obstruction can be higher than that of the transmissive obstruction.

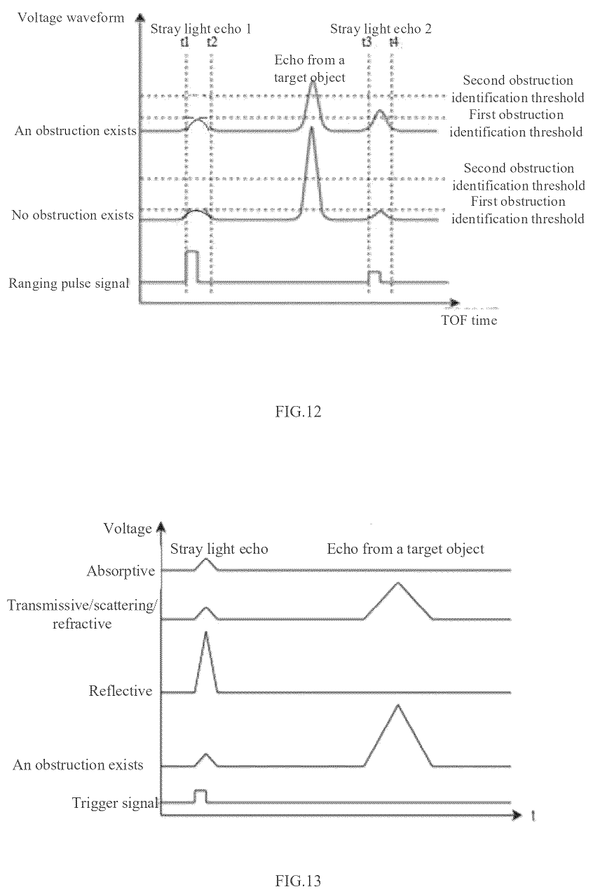

FIG. 13 shows another example schematic diagram of pulse signals with various types of obstructions, consistent with some embodiments of this disclosure. Referring to FIG. 13, the effects of the absorptive obstruction and the reflective obstruction on the echo from the target object are the most serious. The blocking severity degrees of the two types of obstructions are severer. The effects of the transmissive obstruction, the scattering obstruction and the refractive obstruction on the echo from the target object are less. The blocking severity degrees of the three types of obstructions are lighter.

In some embodiments, when the obstruction exists is determined, the number of first light-emitting channels, which correspond to stray light echoes reaching the obstruction identification threshold, in each light emitter bank can be counted. The blocking degree of the obstruction can be determined based on the number of first light-emitting channels.

In some embodiments, the greater the counted number of first light-emitting channels in a light emitter bank is, the greater the blocking degree of the obstruction within the probe field of view range corresponding to the light emitter bank is. For example, each light emitter bank includes 16 light-emitting channels. If the number of first light-emitting channels, which correspond to stray light echoes reaching the obstruction identification threshold, in a light emitter bank is 12, the blocking degree of the obstruction within the probe field of view range corresponding to the light emitter bank is higher than a light emitter bank in which the number of first light-emitting channels, which correspond to the stray light echoes reaching the obstruction identification threshold, is 10.

In some embodiments, when an obstruction exists is determined, alarm information can be outputted.

The alarm information can be used for indicating one or more of the following: the presence of an obstruction, a region in which the obstruction is located, the type of the obstruction, and control information. The control information can be used for controlling the LiDAR or a device mounted on the LiDAR.

In some embodiments, in a case where the type of the obstruction is a non-transmissive obstruction and the area in which the obstruction is located is large, the point cloud data collected at this point can be not credible. The control information can be outputted. The input of the LiDAR to the vehicle perception system can be controlled to be switched off based on the control information. The LiDAR can be detected and controlled to sends no erroneous point cloud information to the vehicle perception system, based on the control information.

In some embodiments, in a case where the blocking degree is severe, control information can also be outputted to control the execution of faulty action. For example, a vehicle with a LiDAR travels at a high speed. A braking or deceleration operation can be triggered while the LiDAR is switched off, when an alarm information is received.

The above-described method for detecting an obstruction can be performed by a LiDAR. For example, the respective steps of the above-described method can be executed using a processor inside the LiDAR. For another example, the respective steps of the above-described method can be performed by a terminal device connected to the LiDAR. The terminal device can include a processor, a controller, a vehicle, a drone, or a robot.

The serial numbers of the respective steps in the embodiments of this disclosure are not intended to limit the order of execution of the steps. The steps can be executed in parallel or separately.

In some embodiments, the method for detecting an obstruction can be implemented by means of a software program, and the software program runs in a processor integrated into a chip or a chip module. The method can also be implemented by means of software combined with hardware, which is not limited by the present application.

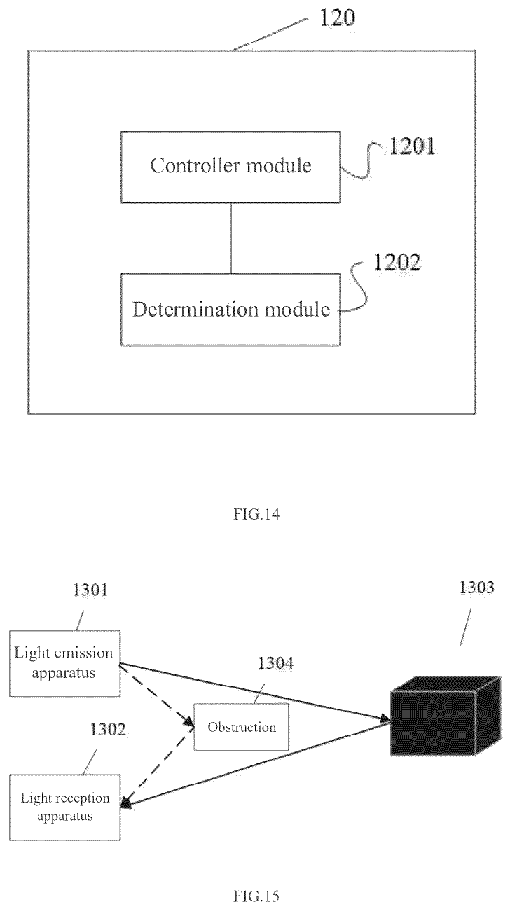

FIG. 14 shows a structure schematic diagram of an example apparatus for detecting an obstruction, consistent with some embodiments of this disclosure. Referring to FIG. 14, a light cover dirt detection apparatus 120 can include a controller module 1201 and a determination module 1202.

The controller module 1201 can control the emission of a detection pulse signal within a ranging time window and control the reception of a stray light echo corresponding to the detection pulse signal. The ranging time window can be configured to determine a time of flight between the emission of a probe pulse signal for probing a target object and the reception of an echo from the target object.

The determination module 1202 can determine whether an obstruction exists based on a feature parameter of the stray light echo.

In some embodiments, the controller module can include a controller, a controller circuit, a processor, a processor circuit or other hardware components for controlling. For example, the module can include a processor (e.g., a digital signal processor, microcontroller, field programmable gate array, a central processor, an application-specific integrated circuit, or the like) and a computer program, when the computer program is run on the processor, the function of the module can be realized. The computer program can be stored in a memory (e.g., a random-access memory, a flash memory, a read-only memory, a programmable read-only memory, a register, a hard disk, a removable hard disk, or a storage medium of any other form), or a server. The determination module can include a processor, a processor circuit, a controller, a controller circuit, or other hardware components for determination. For example, the determination module can include a processor and a computer program, when the computer program is run on the processor, the function of the determination module can be realized.

In some embodiments, the controller module 1201 can control a light emission apparatus to emit the detection pulse signal within a first-time window that is at an end position within the ranging time window. The controller module 1201 can control the light emission apparatus to emit the detection pulse signal within a second-time window. The second-time window is within the ranging time window. The second-time window can be changed based on the reception time of the echo from the target object.

In some embodiments, the controller module 1201 can control the light emission apparatus to emit the detection pulse signal within a first ranging time window. The first ranging time window is configured to determine a time of flight between the emission of a probe pulse signal for probing a short-range target object and the reception of an echo from the short-range target object.

In some embodiments, the controller module 1201 can control the light emission apparatus to emit the detection pulse signal within a second ranging time window. The second ranging time window is configured to determine a time of flight between the emission of a probe pulse signal for probing a long-range target object and the reception of an echo from the long-range target object.

For more details on the working principle and working mode of the apparatus 120 for detecting an obstruction, reference can be made to the relevant descriptions in FIG. 4 to FIG. 13 and corresponding embodiments. The details are not repeated here.

In some embodiments, the apparatus for detecting an obstruction can be a chip with an obstruction detection function in a LiDAR or a terminal device, such as a system-on-a-chip (SOC), a baseband chip, or the like. Or the apparatus for detecting an obstruction can be a module including a chip with an obstruction detection function in a LiDAR or a terminal device. Or the apparatus for detecting an obstruction can be a chip module with a data processing function chip. Or the apparatus for detecting an obstruction can be a LiDAR or a terminal device.

FIG. 15 shows an example structure schematic diagram of a LiDAR, consistent with some embodiments of this disclosure. Referring to FIG. 15, the LiDAR includes at least one light emission apparatus 1301 and at least one light reception apparatus 1302. The LiDAR can emit a probe pulse signal or a detection pulse signal through the light emission apparatus 1301. The light reception apparatus 1302 can receive an echo of the probe pulse signal reflected by a target object 1303. Or the light reception apparatus 1302 can receive a stray light echo of the detection pulse signal reflected by an obstruction 1304.

Further, at least one light reception apparatus 1302 can be provided in correspondence with at least one light emission apparatus 1301, respectively.

The respective modules/units included in the respective apparatuses and products described in the embodiments can be software modules/units, hardware modules/units, or partly software modules/units and partly hardware modules/units. For example, for apparatuses and products applied to or integrated into a chip, modules/units contained therein can be implemented by means of hardware such as circuits, or at least part of the modules/units can be implemented by means of a software program running on a processor integrated into the chip, and the remaining, if any, modules/units can be implemented by means of hardware such as circuits; for apparatuses or products applied to or integrated into a chip module, modules/units contained therein can be implemented by means of hardware such as circuits, where different modules/units can be located in the same component (e.g., a chip, a circuit module, or the like) or different components in the chip module, or at least some of the modules/units can be implemented by means of a software program running on a processor integrated into the chip module, and the remaining, if any, modules/units can be implemented by means of hardware such as circuits; for apparatuses or products applied to or integrated into a terminal, modules/units contained therein can be implemented by means of hardware such as circuits, where different modules/units can be located in the same component (e.g., a chip, a circuit module, or the like) or different components in the terminal, or at least some of the modules/units can be implemented by means of a software program running on a processor integrated into the terminal, and the remaining, if any, modules/units can be implemented by means of hardware such as circuits.

This disclosure also discloses a storage medium. The storage medium is a computer-readable storage medium with a computer program stored thereon, and the computer program, when run, is capable of executing the steps of the above-described method. The storage medium can include a read-only memory (ROM), a random-access memory (RAM), a magnetic disc or a compact disc. The storage medium can further include a non-volatile memory or a non-transitory memory.

This disclosure also discloses a terminal device. The terminal device can include a memory and a processor. The memory has stored thereon a computer program runnable on the processor. The processor, when running the computer program, can perform the steps of the above-described method. Optionally, the terminal device includes any of the apparatuses for detecting an obstruction and the LiDAR described above.

The terms “or” and “and/or” of this disclosure describe an association relationship between associated objects, and represent a non-exclusive inclusion. For example, each of “A and/or B” and “A or B” can include: only “A” exists, only “B” exists, and “A” and “B” both exist, where “A” and “B” can be singular or plural. For another example, each of “A, B, and/or C” and “A, B, or C” can include: only “A” exists, only “B” exists, only “C” exists, “A” and “B” both exist, “A” and “C” both exist, “B” and “C” both exist, and “A”, “B”, and “C” all exist, where “A,” “B,” and “C” can be singular or plural. In addition, the character “/” herein indicates that the associated objects before and after the character are in an “or” relationship.

The term “plurality of” and “multiple” of this disclosure refer to a number of two or more. For example, multiple objects can include two objects, or more than two objects.

The descriptions of “first”, “second”, or the like of this disclosure are only for the purpose of illustrating and distinguishing between the objects described. The descriptions of “first”, “second”, or the like in the embodiments of this disclosure do not represent any particular order, and do not represent any special limitation on the number of devices in this disclosure, which is not limit in this disclosure.

The term “connection” of this disclosure refers to various connection methods such as direct connection or indirect connection to achieve communication between devices, which is not limit in this disclosure.

In some embodiments, the processor can be a central processing unit (CPU). The processor can also be a general-purpose processor, a digital signal processor (DSP), an application-specific integrated circuit (ASIC), a field-programmable gate array (FPGA), another programmable logic device, a discrete gate, a transistor logic device, or a discrete hardware component. The general-purpose processor can be a microprocessor or any conventional processor.

It is to be understood that the memory of this disclosure can be a volatile memory or a non-volatile memory, or can include both a volatile memory and a non-volatile memory. The non-volatile memory can be a ROM, a programmable ROM (PROM), an erasable PROM (EPROM), an electrically EPROM (EEPROM) or a flash memory. The volatile memory can be a RAM, which is used as an external cache. By way of illustrative but not limiting description, various forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM).

The embodiments described above can be implemented, in whole or in part, in software, hardware, firmware, or any combination thereof. If implemented in software, the embodiments described above can be implemented, in whole or in part, in the form of a computer program product. The computer program product includes one or more computer instructions or computer programs. The computer instructions or computer programs, when loaded or executed on a computer, produce, in whole or in part, processes or functions in accordance with this disclosure. The computer can be a general-purpose computer, a special-purpose computer, a computer network or another programmable apparatus. The computer instructions can be stored in a computer-readable storage medium or transmitted from one computer-readable storage medium to another computer-readable storage medium, for example, the computer instructions can be transmitted, by wired or wireless means, from one web site, computer, server or data center to another web site, computer, server or data center. The computer-readable storage medium can be any available medium to which a computer can access, or a data storage device such as a server or data center containing one or more collections of available media. It is to be understood that in various embodiments of the present application, the serial numbers of the preceding processes do not mean an execution sequence, and the execution sequence of the preceding processes should be determined based on their functions and internal logic, which should not constitute any limitation on implementation processes of this disclosure.

In the various embodiments provided in the present application, it is to be understood that the methods, apparatuses, and systems disclosed herein can be implemented in other ways. For example, the apparatus embodiments described above are merely illustrative; for example, the division of the units is merely a division of logical functions which can be divided in other ways in the actual implementation; for example, various units or components can be combined or integrated into another system, or certain features can be omitted or not implemented. In addition, the coupling or direct coupling or communication connection between each other shown or discussed can be an indirect coupling or communication connection through some interfaces, devices or units, which can be electrical, mechanical or in another form.

The units illustrated as separated components can or cannot be physically separated, and the components shown as units can or cannot be physical units. The units can be located in one place or can be distributed over a plurality of network units. Some or all of these units can be selected based on practical requirements, to achieve objects of the solutions in the embodiments herein.

In addition, various functional units in respective embodiments of the application can be integrated into one processing unit, each unit can be physically presented separately, or two or more units can be integrated into one unit. The above integrated unit can be implemented in the form of hardware or in the form of hardware plus software function unit.

The above integrated unit implemented in the form of software function unit can be stored in a computer-readable storage medium. The above software function unit is stored in a storage medium and contain a number of instructions to enable a computer device (which can be a personal computer, a server or a network device) to perform some of the steps of the method described in various embodiments of the application.

Although this disclosure is disclosed as above, this disclosure is not limited thereto. Any person skilled in the art can make various changes and modifications without departing from the spirit and scope of this disclosure, and therefore the scope of protection of this disclosure shall be subject to the scope defined by the claims.

1-22. (canceled)

23. A method for detecting an obstruction for a LiDAR, comprising:
emitting, within a ranging time window, a detection pulse signal for detecting the obstruction and a probe pulse signal for probing a target object;
receiving a stray light echo corresponding to the detection pulse signal and an echo from the target object in the ranging time window; and
determining a presence of the obstruction based on a feature parameter of the stray light echo.

24. The method of claim 23, wherein determining the presence of the obstruction based on the feature parameter of the stray light echo comprises:
comparing the feature parameter of the stray light echo and an obstruction identification threshold; and
determining that the obstruction exists in response to the feature parameter of the stray light echo reaching the obstruction identification threshold, wherein the feature parameter of the stray light echo comprises at least one of a pulse width, a peak value, or an integral value of the stray light echo.

25. The method of claim 24, further comprising:
dynamically adjusting the obstruction identification threshold based on a change in an environment in which the LiDAR is located.

26. The method of claim 23, wherein emitting, within the ranging time window, the detection pulse signal for detecting the obstruction and the probe pulse signal for probing a target object comprises:
emitting the detection pulse signal within a first-time window; or
adjusting a second-time window based on a reception time of the echo from the target object and emitting the detection pulse signal within the second-time window,
wherein the first-time window is a latter portion of the ranging time window, and the second-time window is within the ranging time window.

27. The method of claim 23,
wherein the ranging time window comprises a first ranging time window and a second ranging time window,
wherein emitting, within the ranging time window, the detection pulse signal for detecting the obstruction and the probe pulse signal for probing a target object comprises at least one of:
emitting the detection pulse signal and the probe pulse signal within the first ranging time window; and
emitting the detection pulse signal within the second ranging time window, and
wherein receiving the stray light echo corresponding to the detection pulse signal and the echo from the target object in the ranging time window comprises at least one of:
receiving the stray light echo corresponding to the detection pulse signal and the echo from a short-range target object in the first ranging time window; and
receiving the stray light echo corresponding to the detection pulse signal and the echo from a long-range target object in the second ranging time window.

28. The method of claim 23, wherein a time length of a time window for detecting the obstruction is less than a time length of the ranging time window.

29. The method of claim 23, wherein a light intensity of the detection pulse signal is less than a light intensity of the probe pulse signal.

30. The method of claim 23, further comprising:
determining a region in which the obstruction is located based on a point cloud feature deviation between a first point cloud data and a second point cloud data, wherein the first point cloud data is a point cloud data collected before the obstruction is detected, the second point cloud data is a point cloud data collected after the obstruction is detected, and the point cloud feature deviation comprises at least one of a distance deviation or a reflectivity deviation.

31. The method of claim 30, wherein determining the region in which the obstruction is located based on the point cloud feature deviation between the first point cloud data and the second point cloud data comprises:
determining, based on the point cloud feature deviation, an abnormal point cloud data in the second point cloud data; and
determining, based on a probe field of view range of a probe pulse signal corresponding to the abnormal point cloud data, the region in which the obstruction is located.

32. The method of claim 30, further comprising:
in response to each frame of a plurality of consecutive point clouds having an obstruction in a same region, determining that an obstruction exists in the region.

33. The method of claim 23, further comprising:
determining a region in which the obstruction is located, based on a position at which a light-emitting channel emitting the detection pulse signal is located in a vertical direction and a horizontal field of view corresponding to the light-emitting channel.

34. The method of claim 33,
wherein the region in which the obstruction is located comprises a vertical position and a horizontal position, and
wherein determining the region in which the obstruction is located based on the position at which the light-emitting channel emitting the detection pulse signal is located in the vertical direction and the horizontal field of view corresponding to the light-emitting channel comprises:
determining the vertical position based on a position at which a light emitter bank, in which the light-emitting channel is located, is located in the vertical direction; and
determining the horizontal position based on the horizontal field of view.

35. The method of claim 30, further comprising:
determining a plurality of regions in which an obstruction is located; and
determining that the obstruction exists in the plurality of regions in response to the plurality of regions being spatially continuous.

36. The method of claim 23, wherein the stray light echo is an echo corresponding to detection pulse signals emitted by a plurality of light-emitting channels in a plurality of light emitter banks, and the method further comprises:
determining a number of first light-emitting channels, which correspond to stray light echoes reaching an obstruction identification threshold, in a light emitter bank; and
determining the obstruction exist is in response to the number of first light-emitting channels in the light emitter bank reaching a first threshold.

37. The method of claim 23, wherein determining the presence of the obstruction based on the feature parameter of the stray light echo comprises:
in response to the feature parameter of the stray light echo reaching a first obstruction identification threshold, determining that a first obstruction exists, wherein a type of the first obstruction is a transmissive obstruction; or
in response to the feature parameter of the stray light echo reaching a second obstruction identification threshold, determining that a second obstruction exists, wherein a type of the second obstruction is a non-transmissive obstruction, and the second obstruction identification threshold is greater than the first obstruction identification threshold.

38. The method of claim 23, wherein the stray light echo comprises echoes corresponding to detection pulse signals emitted by a plurality of light-emitting channels in a plurality of light emitter banks, and the method further comprises:
in response to a determination that the obstruction exists, determining a number of a plurality of first light-emitting channels in a light emitter bank, wherein the stray light echo corresponding to a first light-emitting channel in the plurality of first light-emitting channels reaches an obstruction identification threshold; and
determining a type of the obstruction based on the number of the plurality of first light-emitting channels.

39. The method of claim 23, further comprising:
in response to a determination that the obstruction exists, outputting alarm information;
wherein the alarm information is configured to indicate one or more of the following: the presence of the obstruction, a region in which the obstruction is located, a type of the obstruction, or a control information, and
wherein the control information is configured to control the LiDAR or a device mounted on the LiDAR.

40. An apparatus for detecting an obstruction for a LiDAR, comprising:
a control module configured to control an emission of a detection pulse signal for detecting the obstruction, an emission of a probe pulse signal for probing a target object within a ranging time window, a reception of a stray light echo corresponding to the detection pulse signal, and a reception of an echo from the target object in the ranging time window; and
a determination module configured to determine a presence of the obstruction based on a feature parameter of the stray light echo.

41. A computer-readable storage medium having a computer program stored thereon, which, when executed by a processor, executes the method of claim 23.

42. A LiDAR, comprising:
a light emission apparatus configured to emit a probe pulse signal for probing a target object and a detection pulse signal for detecting an obstruction;
a light reception apparatus configured to receive an echo reflected by the target object from the probe pulse signal and a stray light echo corresponding to the detection pulse signal; and
a controller having a computer program stored thereon, wherein the controller, when running the computer program, executes the method of claim 23.
